(19) United States
(12) Patent Application Publication
(10) Pub. No.: US 2007/0245880 A1
(43) Pub. Date: Oct. 25, 2007

(54) Tailor/ custom made marching percussion stick bag

(76) Inventor: Ray Perkins, Atlanta, GA (US)

Correspondence Address: RAY A. PERKINS JR, 2460 ALSTON DR., SE, ATLANTA, GA, 30317, US

(21) Appl. No.: 11/367,567

(22) Filed: Mar. 3, 2006

(51) Int. Cl. G10D 13/02

(52) U.S. Cl. 84/422.4

(57) ABSTRACT

A device for storing and retrieving of one or more pairs of drumsticks/mallets/beaters, which is made in a variety of colored fabric textures. Comprising in a combination of: a casing (12) open at its top (14) and defining a cavity or a pocket lining. The other end of the casing (18) is closed for stopping the drumsticks from falling/coming out. Consisting of two (2) stitched Velcro straps (16) to be secured or strap to the marching percussion hardware. These straps are equally stitched parallel at each end of the casing.

### CROSS REFERENCE TO RELATED APPLICATIONS

Not Applicable

### FEDERALLY SPONSORED RESEARCH

Not Applicable

### SEQUENCE LENGTH OF PROGRAM

Not Applicable

### BACKGROUND OF THE INVENTION

1. Field of Invention

A percussionist in a modern marching band/orchestra is frequently require to manipulate and change to a variety of sticks/mallets/beaters for sound effects, and appearance purposes during the course of there performance.

2. Background of Invention

“The Hand Made Marching Stick Bags” are for the marching percussionist that is capable of storing drumsticks/mallets/beaters. Comprising in a combination of: a casing open at its top and defining a cavity with a pocket lining. The other end of the casing is closed for stopping the drumsticks from falling/coming out. The two (2) stitched Velcro straps are use for securing or to be strapped to the marching percussion instrument. These strap are equally stitched parallel at each of the casing one at the top and the other Velcro Strip near the base.

The purpose of the Stick Bag is to provide an alterative from the counterparts Stick Bags. The Stick Bag is made mostly for the use of the Marching Percussionist but came be used for other applications pertaining to drums. They mount to on the side of the marching drum with either Velcro Straps or just a Tie Down Cord String. Constructed of durable (polyurethane/synthetic) fabric to withstand multiple climates for repeated use time after time.

The second most reason and function of the stick bags is to hold/keep drumsticks at or near the percussionist that is currently being playing during a performance or event. It is for them to have stick readily and waiting until needed during playing. The stick bags use is a choice of for the percussionist to alternate between (2) two different pairs of playing sticks/mallets/or beaters. Not only for easy access, they can also be used for safekeeping or storage when the sticks are not in use.

I consider the Stick Bags to be in the category of a Design Patent.

Please direct me if there might be some type of variance in the search title of this patent design. There are other products in the same field of market that make these stick bags. However, what makes my product/invention stand out is that my Stick Bags has a different design/structure/and appearance. Other manufactures produce the same product/invention and they all look/have the same appearance; the structure andsurface on all of them is of the same basic color—BLACK. The only difference amongst their product is that their own company name is printed in bold print on the front, which takes up the entire length of the stick bag.

### BRIEF DESCRIPTION OF DRAWINGS

### Drawing Reference Numerals

10 Main Body
12 Top Opening
14 Velcro Assembly—3″×⅜″
16 Base/Closure

### Parts List

18 Pre cut Fabric
20 Pre Cut Foam
22 Pre Cut Backing
24 Nylon Tread
26 Nylon Velcro Strips
28 Nylon Base
30 “XL” Nylon Base
32 Cord Sleeve
34 Cord Lock
36 Draw Cord
38 Fabric Body
40 “XL2” Fabric body

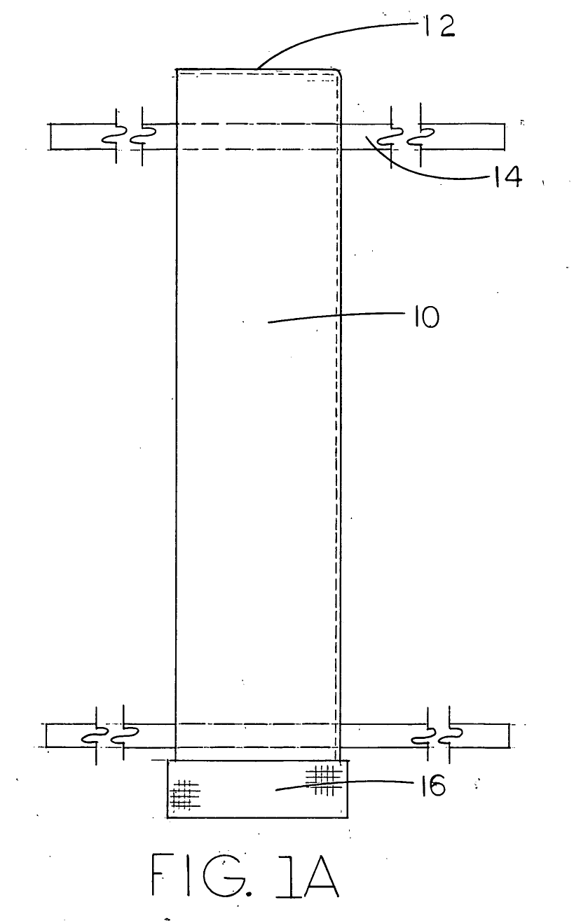

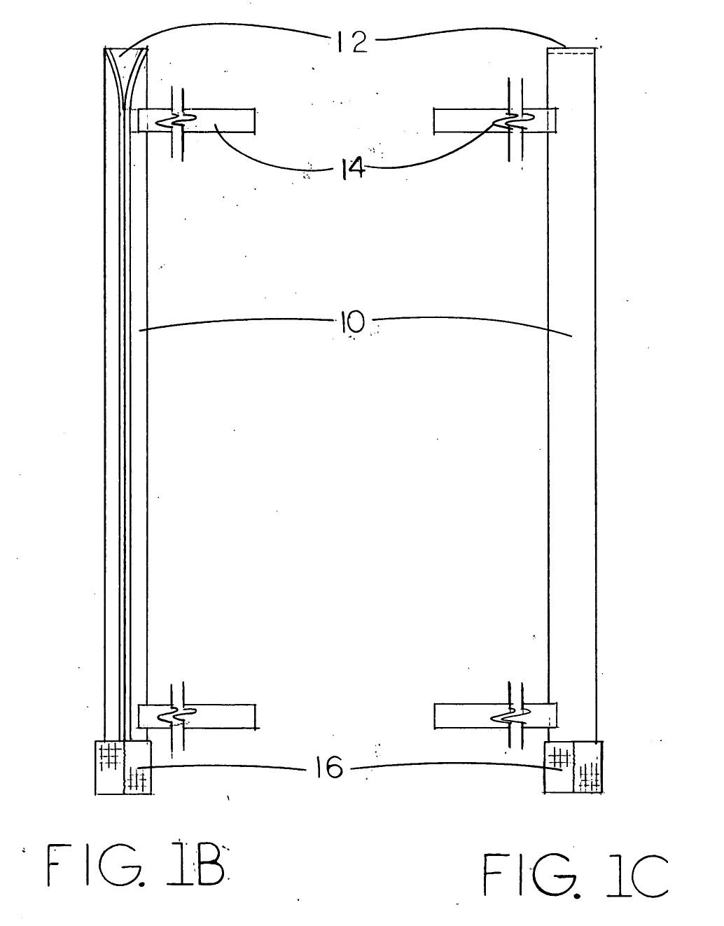

### DETAILED DESCRIPTION FIGS. 1A & 2B

18 Precut Assorted Fabric 6½″×15¾″
   Thickness: 1.5″ mm to 2.5″ mm
20 Precut Foam 6″ W×14″ L
   Thickness: ⅛″
22 Precut Backing
   Thickness: 1.5″ mm to 2.5″ mm
24 Nylon Thread ⅜″ W×6″ to 8″ L
   Thickness: 2.5 mm to 3.5 mm
26 Velcro Strips: ⅜″ W×3″ to 4″ L
28 Nylon Base 2″ W×3¼″ L
   Thickness: 2.5 mm to 3.5 mm
28b Nylon Base 2″ W×6¼″ L
   Thickness: 2.5 mm to 3.5 mm
30 Nylon Base 2″ W×6¼″ L
   Thickness: 2.5 mm to 3.5 mm
40 Precut Fabric “XL2” 14″×7½″
   Thickness: 1.5″ mm to 2.5″ mm

FIG. 1A Illustrates the front view of the Marching stick bag.

FIG. 1B The right of the embodiment has a slit/opening 14 along side of the bag from the top.

FIG. 1C Shows the left perspective of the embodiment. It illustrates as the 1″ slit along side of stick bag.

FIG. 1D Illustrates the rear view of the stick bags with the two (2) Velcro assembly.

FIG. 1E Broken lines Illustrates wherein the drumsticks have been fully inserted into the opening casing.

FIG. 1F Shows the view of the Logo that has been placed onto the Main Body Casing.

Note:

The actual size of the Stick Bag is 3″ W×14″ L×¾″ D
In addition, the corresponding drawings are at ⅔ Dimension.

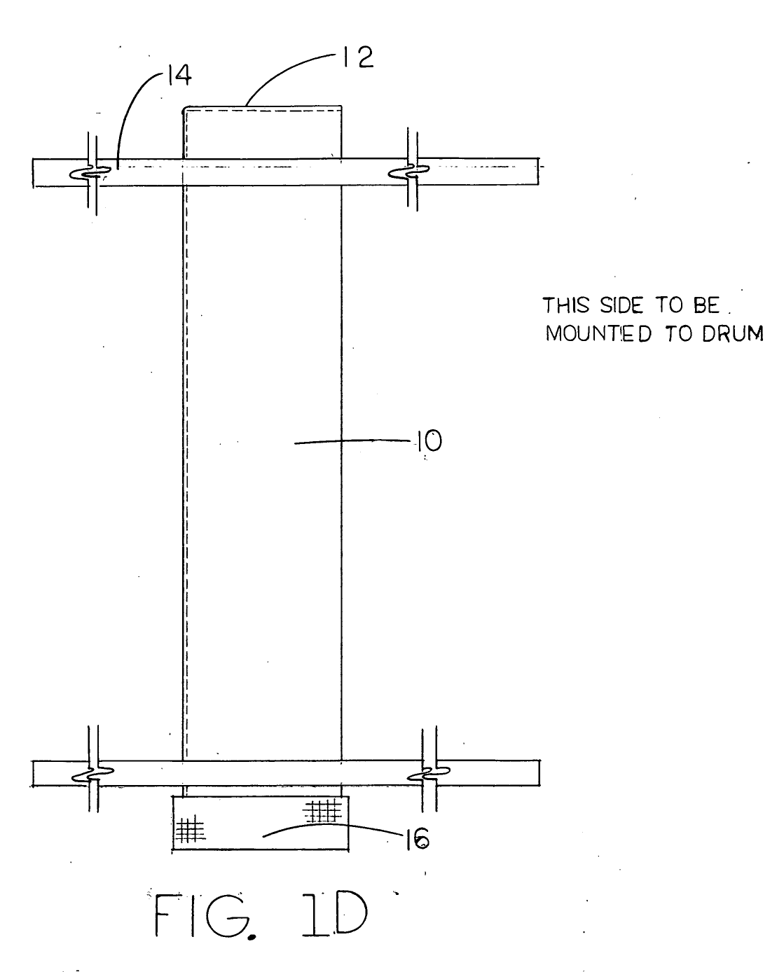

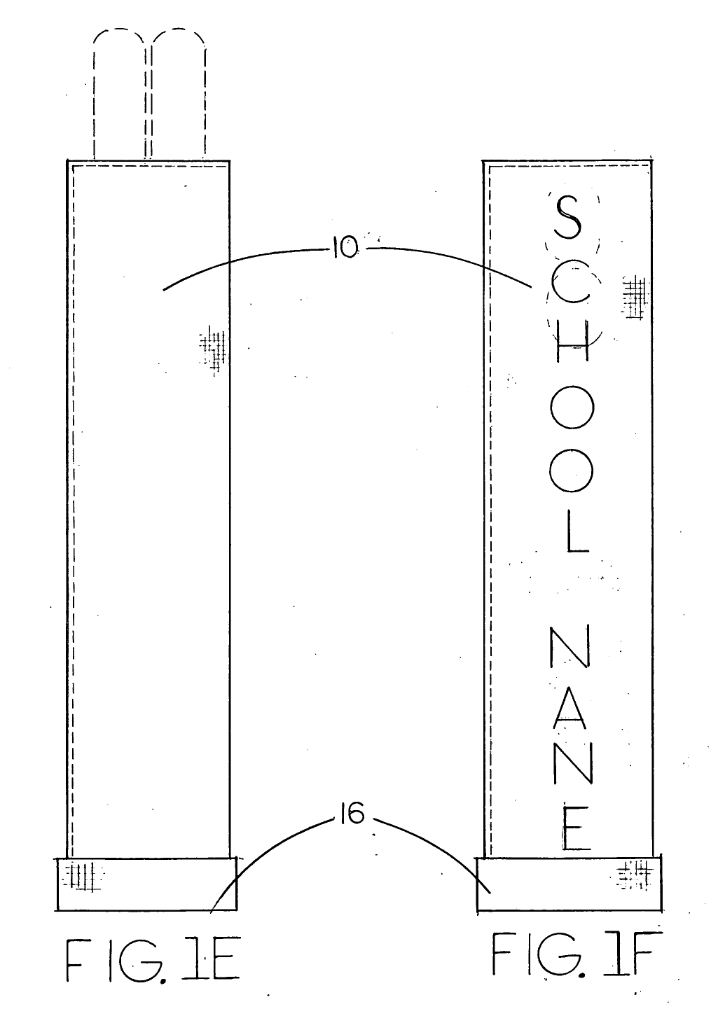

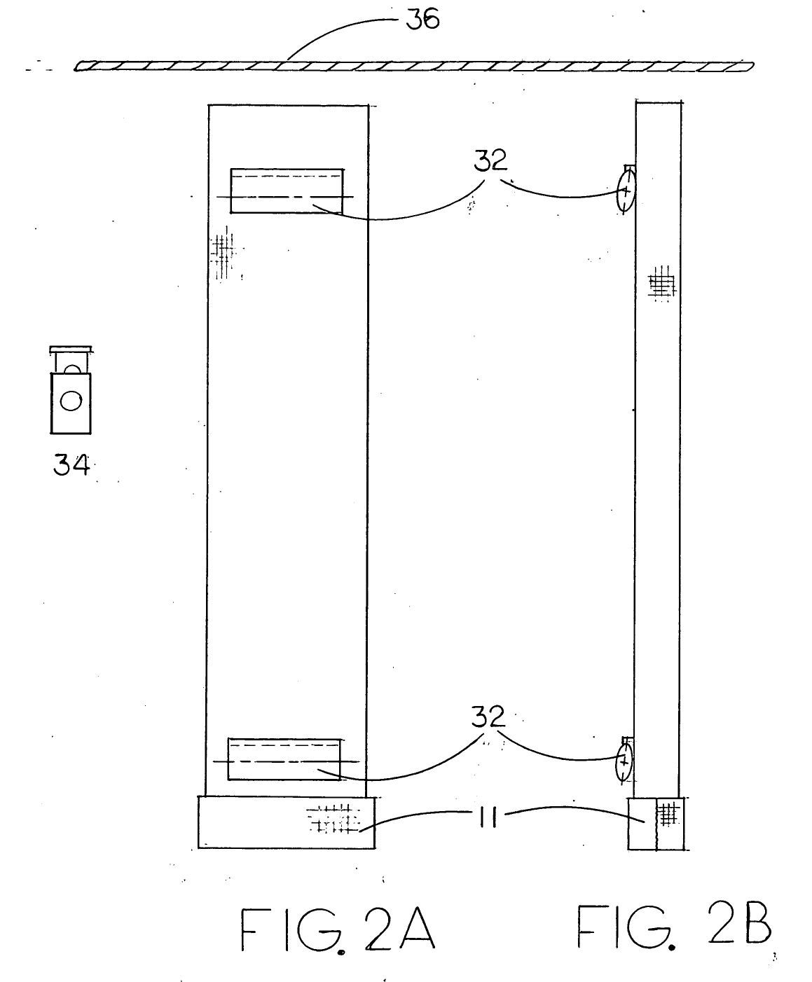

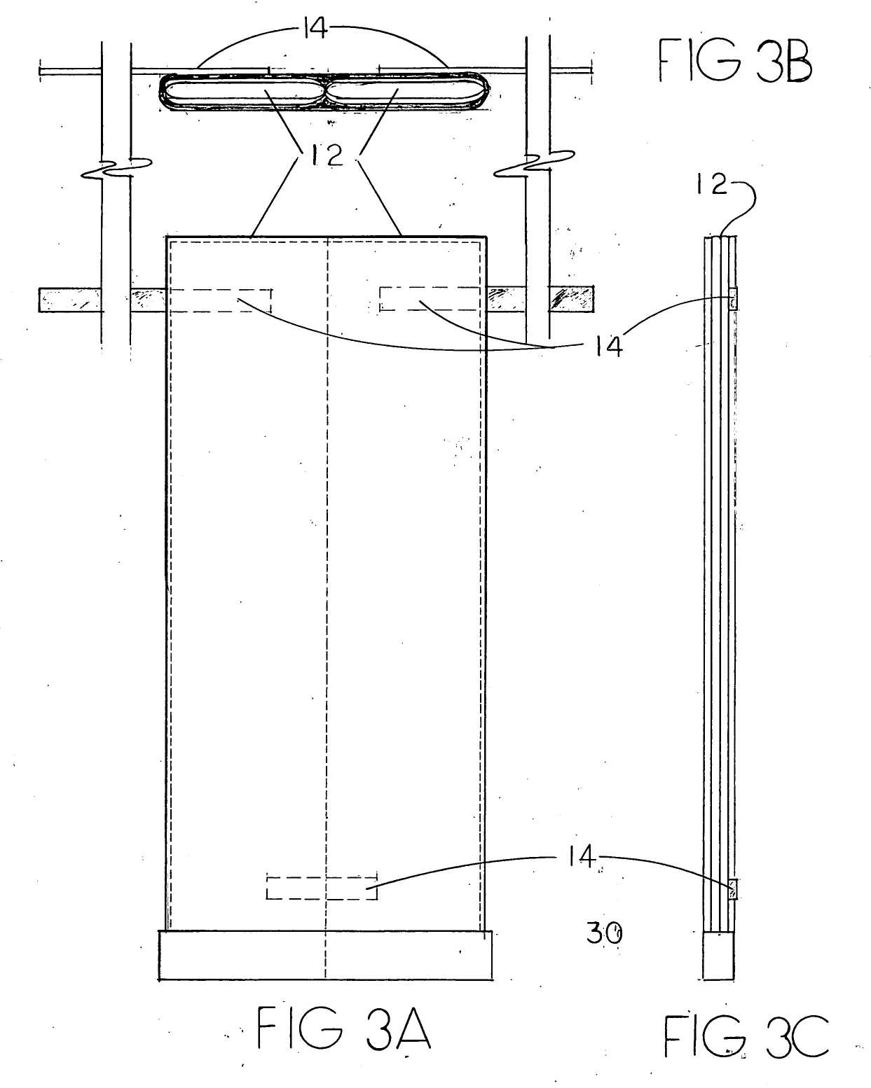

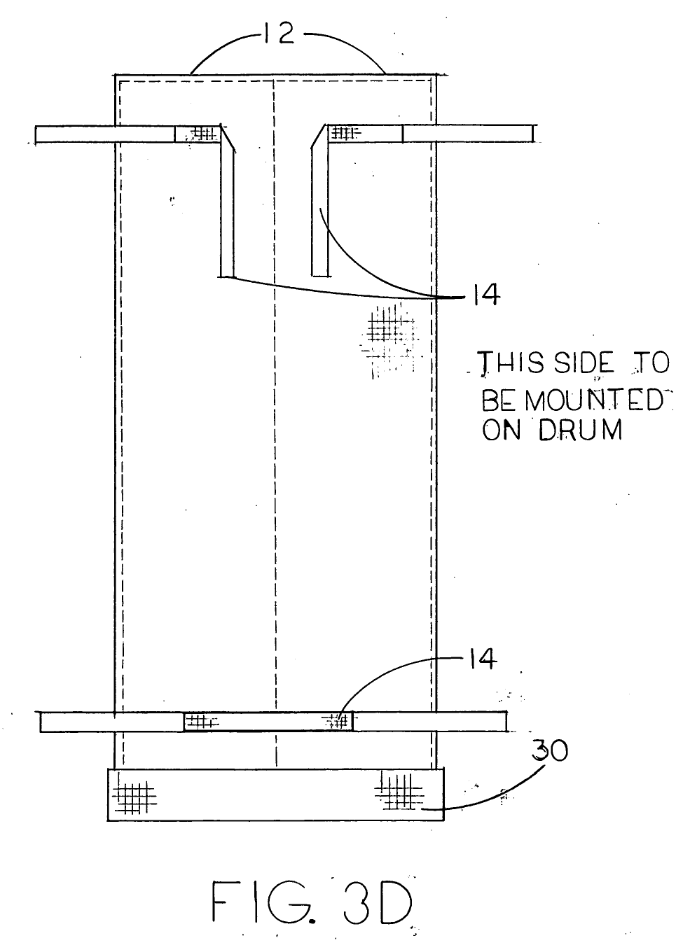

FIG. 2-3—Additional Embodiments

FIG. 2A Shows the rear view but with the Velcro Strips have been omitted, attach the Draw Cord 36 is to be with spring loaded Cord Lock 34. At each ends of the Casing 10, there is a one and a half inch Cord Sleeve 32 sewn to both ends of the Casing 10. This is for the Casing 10 to attach to the marching instrument. However, before this happens you need to sew the Cord Sleeve just right below the 1½″ border at the top and 1½″ from the bottom of the casing 10. Now the Draw Cord 36 is inserted through the sleeve 32, as Illustrated FIG. 2A.

FIG. 3A Shows the “XL” Percussion Drum Stick Bag in its Front view.

FIG. 3B Illustrates the Rear of the “XL” Percussion bag with the Velcro assembly.

FIG. 3C Shows the Left Side

FIG. 3D Shows the top View.

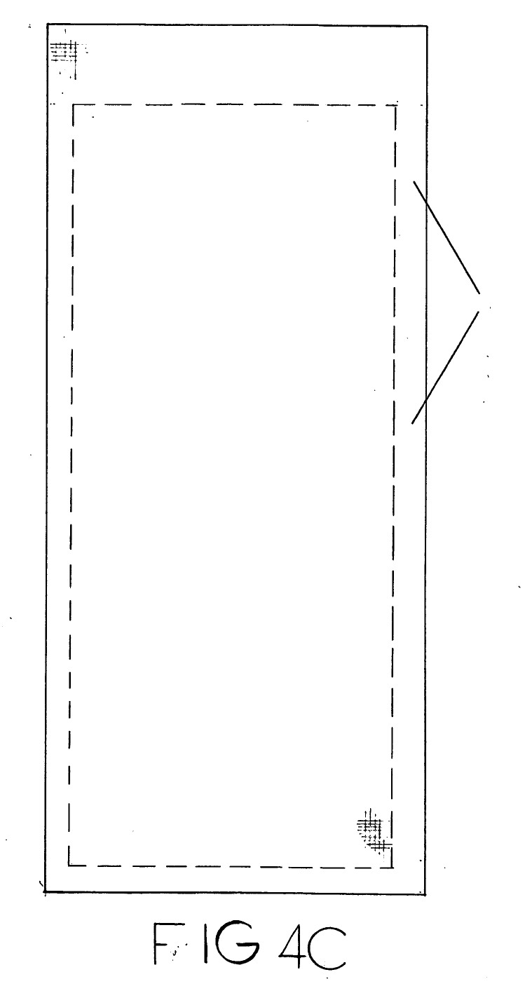

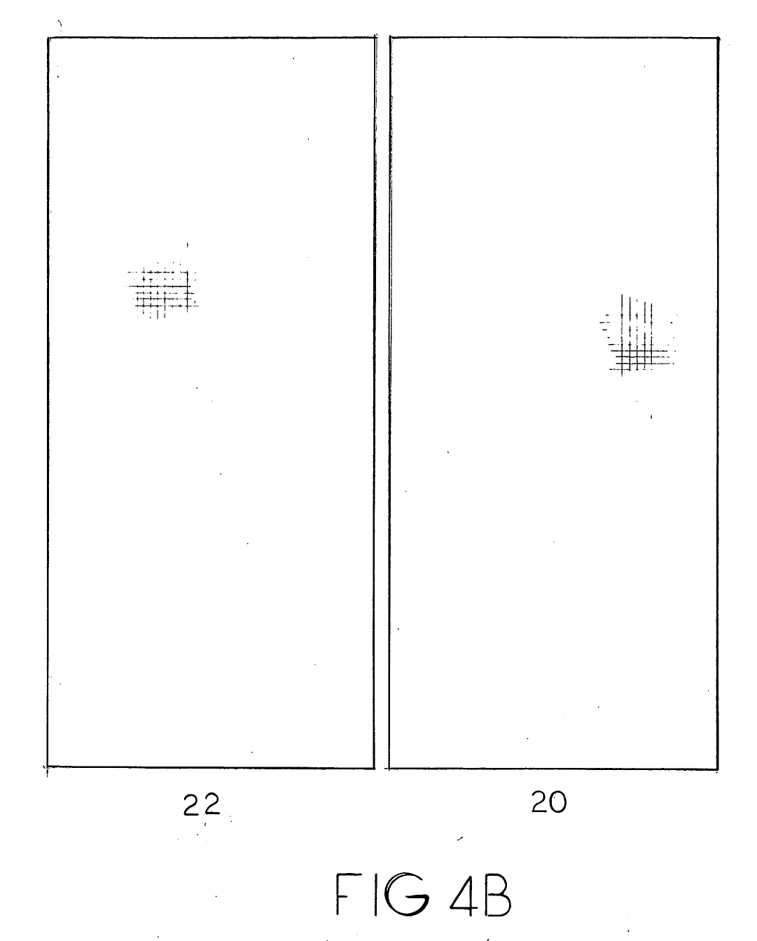

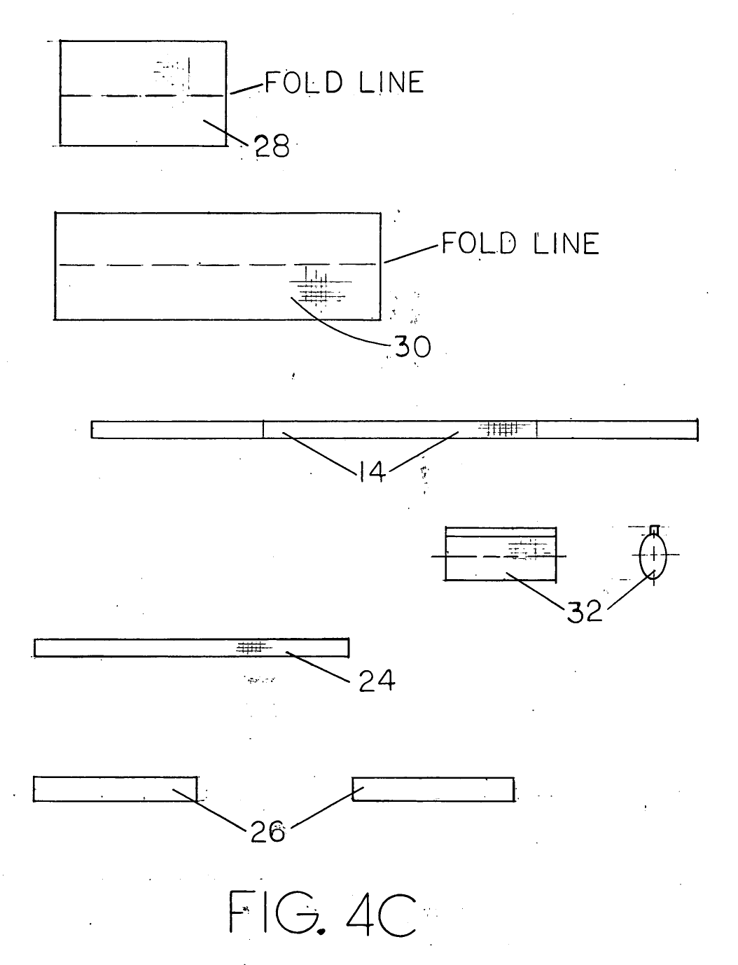

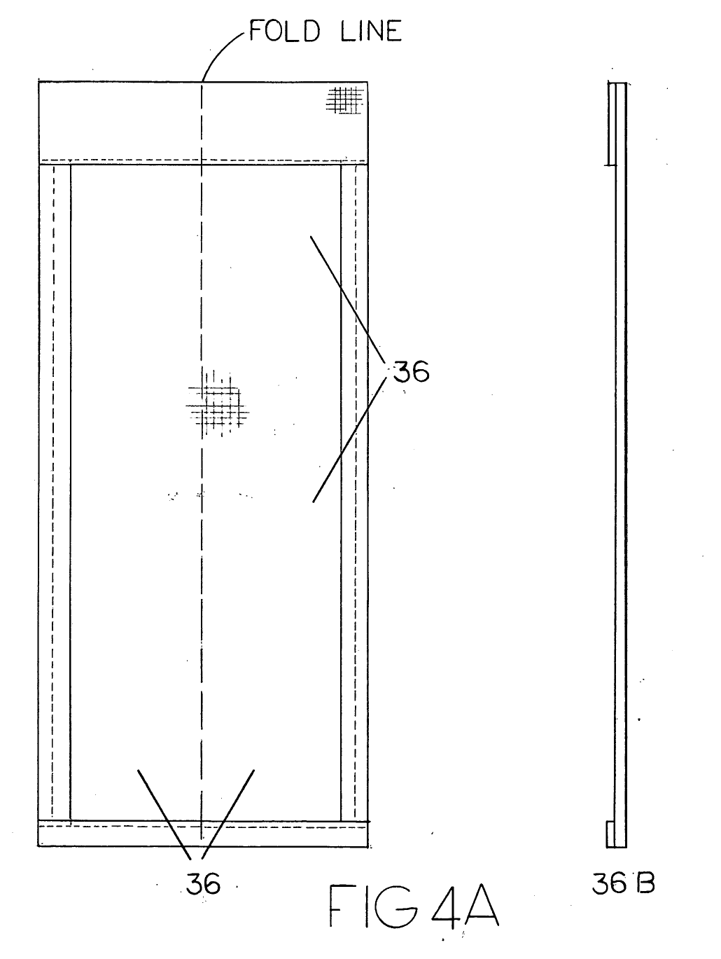

FIG. 4A Shows the actual Fabric Body 36 along with the fold line, but are without Velcro Assembly and the right view 36B.

FIG. 4A Shows the two assorted disassembled part of the foam 22 and backing 20.

FIG. 4B Shows the assorted parts list or disassemblies.

FIG. 4C Shows the placement/centering of 20 and 22 on Fabric Body 36.

FIG. 4D Shows additional separated components for the assembly of the “Stick Bag” the “XL” and the “XL2″.

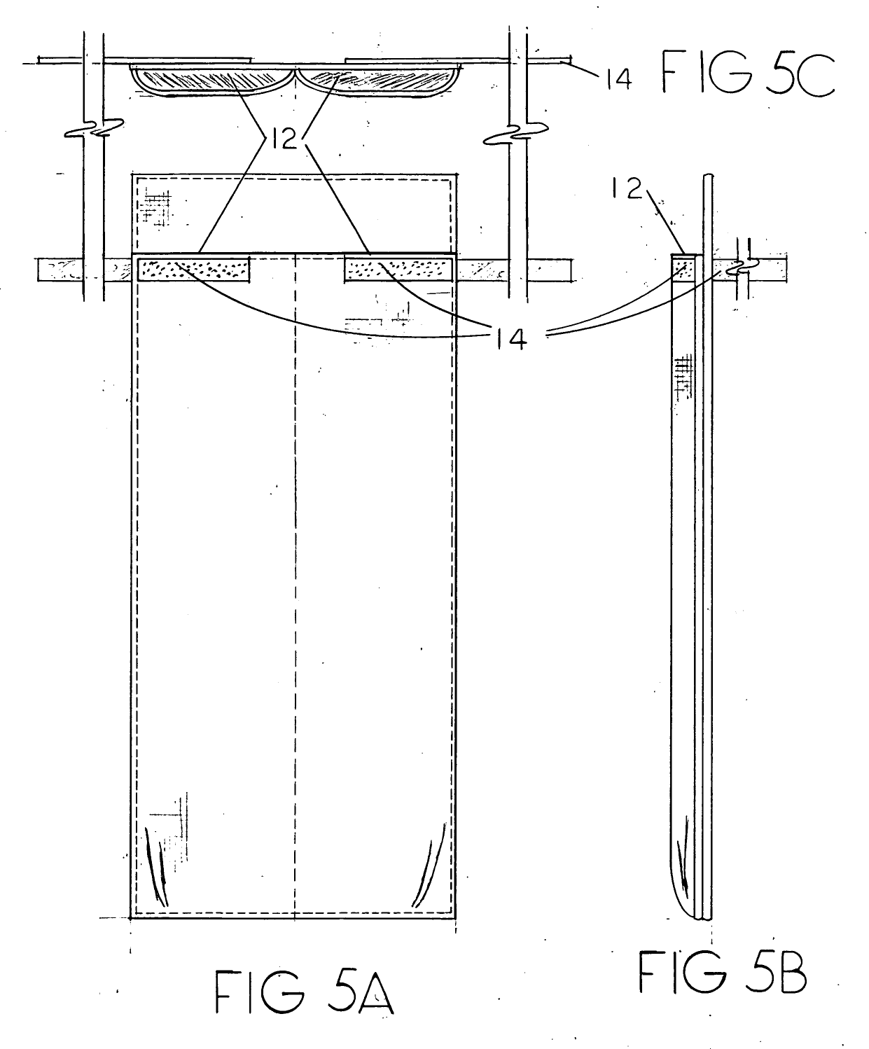

FIG. 5 Shows front side of “XL2” along with male/female side of 14.

FIG. 5B Shows right side view of “XL2”

FIG. 5C Shows the top side view of “XL2”

### DETAILED DESCRIPTION

A preferred embodiment of the percussion stick bag of its present design is illustrated in FIG. 1A (front view) and FIG. 1F (rear).

The stick bag has an opening end of the embodiment. This is for the receiving end to hold the pair of drumsticks, when placed in the bag by the percussionist. This part of the fabric is flexible at the opening 12, which looks to be oval FIG. 1B. This fabric 18, is durable and mostly made up of upholstery material for withstanding outside extreme conditions and climate.

Second application is the foam 20; the third application is the backing 22. Then to assemble the three, just place outside fabric face down, next—center the foam and the backing together making sure the Foam is sandwiched in between the Fabric and the Backing, and at the bottom have the two backing/foam placed ¼ from the edge and also the sides.

The top should have a border of about one and a half (1½″) from the edge. First fold both the side edges up and place a couple of safety pens/staples to help keep in place for sewing, then along the right side, as you sew up the edges have the Velcro assembly over the side edges and sew across both the Velcro Assembly as you pass each one. Now as the finish part do not sew up the pouch completely, leave a 1″ gap/opening from the top, cut and tie or place a firm knot at each line of sewing to ensure that it is secure of defects or thread pulling out. The pouch assembly is now complete.

After this process is done place the Nylon Base 28 lengthwise, across the bottom of the pouch. Center the pouch about 1″ from the edge of Nylon base 28 fold in the center this will overlap portions of the front and the back of the Pouch. Sew up the sides of the Nylon Base 28. Now this forms the Base 16, next to fill in the gaps in between base 16 and the Pouch place a bead of hot glue lengthwise on both sides of the flap. Not only this base is for ornamental looks the stick bag, but it also act as a reinforcement, and a protector when the bags are placed on the ground/dirt/elements while still mounted to the drum. The Percussion Marching Stick Bag is complete.

The next thing is to apply your logo or the School/Club/Organizations name, these letters will be applied to the main body 10 on the front, just peel off the paper covering on the back of the letters arrange them in the order you want them to be, then to make permanent use a hot glue gun. If you choose to use a logo/name of your group, these letters—as of now, comes in different color thread schemes such as: Blue/Red/Green/Black/White and Gold. In addition, these letters have White Felt backing with an adhesive for application to be placed on the embodiments. Have these letters monogrammed or sewn on permanently not any more other type lettering right now but if see fit to add upcoming merchandise during later development, Please advise.

Please note that the size of letters may vary but the average size of a single manufactured letter is about 1⅜″ H×1½″ W. Therefore making it a maximum of eight characters to be applied to the front of the Stick Bag.

Description of 3A, 3B, 3C, 3D.

In order to assemble the “XL” Percussion Marching Stick Bags FIG. 3A, you will need two of the assembly's 36, first making sure on one of the assembly 36 prep it up for the Velcro Strips to be sewn and secured to just that one side. Starts by using instead of two Velcro assemblies 12 you are to use three. These three assemblies are about 2″ shorter than the original prior Velcro assemblies listed from above.

Have the Fabric Body 36 facing upward, place the first of the three Velcro Assemblies 12 on the top right corner. This is right near the one half (1½″) border about 1″ from the edge, proceed to the same methods as from above by sewing down the center of the Velcro strips an then back across. Do the same for the top left corner of Fabric Body 38. Next for the third Velcro Assembly, proceed to place at the center bottom one half 1½″ from the bottom Body 38 and sew in place down the center twice for a secured fit.

Once the Velcro Strips are on, place both the two assembly's 38 together also pay attention and make sure the two backings sandwiched together and that both the one and half (1½″) border is matching. Align all the corners evenly of the embodiment so that they are squared and flush.

Please understand that these are two regular unfolded Marching Stick bags that make up the “XL” FIG. 3A.

The next move is to sew Stick Bags together by starting at the top corner right below the 1½″ border. With the Velcro Side up on Fabric Body 38 start by sewing from the upper left corner down to the bottom and proceed all the way across from the left bottom corner to the right and the third pass is from the right bottom corner to the top right corner. Please remember that the top of the Stick Bag to leave about a 1½″ gap/space from the top and tie up or knot all of thread ends to secure it from becoming loose.

Now the last stitch method is to be right down the center of Body 38. Start by marking a light calk line after finding the center and proceed to sew down the center, starting at the top and proceed to the bottom. The last move is to apply the Nylon Thread 30, the base of the Body 38. Place the body 38, at the center of the thread 30 lengthwise, giving both sides a 1″ space on both front and back.

Fold up the sides and proceed to secure Nylon Base 30, by sewing up both the edges and finish with the Hot Glue procedure, down the inside and in between the Nylon 30 and the Body 38. The “XL” Marching Stick Bag is complete.

Description of “XL2” FIG. 5A/5B/5C

To prepare the “XL2” bags FIG. 4A for assembly, start by taking the fabric body 10, which is the stick bag without the attachments of the Velcro strips. On the regular Fabric Body 10 place face down with fabric side up, with the top away from you (or the body). Place the Velcro assembly 26 on either side of 10, at the top corner 1½″ down from top and see to it that the ribbon side with the Velcro strips 26 is attached on the fabric side and the other actual female side of the Velcro 26 having the strip extended face down away from fabric body.

Sew assembly on the repeat opposite side of fabric body 10 with the other set of Velcro Strips 26. Once this process is done, take fabric 40 and prepare it by sewing the folded edges all the way around. 14″×7½″ making the sewn edges or hem/border at ¼″ all the way around. Once finish, flip 40 over where the hem/border is face down. Then start by placing the female side of the Velcro Strip 26 to the upper left or right side of the fabric body 40 to be sewn. (This enables the body of FIG. 4A, to be attached to the receiving Velcro Strips 26 or to mate with the female side of the FIG. 4A.) Do/finish/repeat the opposite side the same way the first procedure was done. Once the two separate pieces are completed, it is time to assemble both pieces together.

Take FIG. 4A and 40 for assembly, continue to have FIG. 4A at the same position as before, but it has to be flipped over with the hem side up 4A, and the fabric side of 40 is facing hem side down. Place 40 on top of FIG. 4A, evenly square both the bottom edges/ends. Some excess material of 40 will hang or overlap about a ⅛″ of an inch and that is normal. In addition, the top of 40 will be evenly short by a one half (1½″) from FIG. 4A, and that this will be needed to complete assembly. Now place the complete assembly onto the sewing machine making sure that you start at the top right corner or the off set. Start sewing from the top all the way to the bottom, then across the bottom making sure that the overlapping edges are gradually creased while sewing. This process will take up the excess overhang from both the sides. Then proceed to sew up the left side of the assembly. Tie up the loose ends of the threads once the sewing is completed. Now start at the bottom and find the center of the assembly/pouch, once you have equally located the center. Place pouch/assembly on the sewing machine, with the head/top of the pouch against/towards the operators body proceed to sew down the center all the way up to the offset. By doing this procedure, this will enable the percussionist to be able insert two pairs of mallets/beaters. Once sewing is finish tie up all of the loose ends of all threading. Now the “XL2” FIG. 5A is complete. The only difference between the two “XL'S” is that the base 30 has been omitted and the lower Velcro Strip.

The purpose of the “XL” and the “XL2” Percussion Stick Bag is to make clear and understand concise information of multi purposes and the function of “XL” & “XL2” Marching Stick Bags” FIG. 3A and FIG. 5A besides being able to utilize two pair of drumstick at one time. The “XL” and “XL2” is constructed for the main function of caring additional sticks if so desired; also, it can be used for storage of drumsticks/mallets when not in use. overhang from both the sides. Then proceed to sew up the left side of the assembly. Tie up the loose ends of the threads once the sewing is completed. Now start at the bottom and find the center of the assembly/pouch, once you have equally located the center. Place pouch/assembly on the sewing machine, with the head/top of the pouch against/towards the operators body proceed to sew down the center all the way up to the offset. By doing this procedure, this will enable the percussionist to be able insert two pairs of mallets/beaters. Once sewing is finish tie up all of the loose ends of all threading. Now the “XL2” FIG. 7 is complete. The only difference between the two “XL'S” is that the base #30 has been omitted.

The purpose of the “XL” and the “XL2” Percussion Stick Bag is to make clear and understand concise information of multi purposes and the function of “XL” & “XL2” Marching Stick Bags” FIG. 3A and FIG. 7 besides being able to utilize two pair of drumstick at one time. The “XL” and “XL2” is constructed for the main function of caring additional sticks if so desired; also, it can be used for storage of drumsticks/mallets when not in use.

Using Solid/Bandanna/Paisley/Checker/or plaid textures demonstrates the versatility of the invention and to relay a better understanding of the different fabric textures and color scheme.

The textile are made mostly of 100% Acrylic and Cotton if not available in the100% Polyester with Vinyl Acrylic coating, also the choice to use the assorted nylon textures is another perfect option.

Advantages

Accordingly, besides the objectives and advantages of the tailor made marching percussion stick/mallets bags described in my above patent, several advantages but too much if any here are the advantages.
A) To provide the percussion field a variety in the practice or study to have these stick bags to be more attractive by appearance.
B) To provide schools and other organizations/clubs etc. to utilize and incorporate the organization/clubs/schools the colors of there choice.
C) To provide a large variety of standard durable textile colors.
D) To provide a tailor/custom made feel to each individual of whom utilizes the stick bags.
E) To provide their organization/clubs names or logos on the stick bag to their liking if the Club/Group/Organization see fit.
F) The stick bags will provide and present a streamline look as they are mounted and secured on the musical/rhythm instrument.
G) To provide a more sturdy structured material that these bags are made and constructed for long life and durability from those times when these bags are in constant use or from occasional washing, they will keep their stiffness.

My Stick Bags and what makes it different from the prior stick bag companies Vic Firth/Yamaha/Pearl etc., is that—my stick bags comes in the desired colors that is wanted for their need(s), whether it is to match their school/group/organization/club membership colors and specifications. Secondit is built more durable and sturdy to withstand those sometimes harsh conditions such as—transporting to and from events or outside during weather conditions . . . like rain/sun/sleet/snow elements.

My stick bags can also be made to accommodate not only the (1) one pair of drumsticks but also (2) pair of drum sticks at one time, which will be called the “XL” and “XL2” Marching Percussion Stick Bags.

Third is that these stick bags can also be accommodated with their schools or groups name on the front of the stick bags; as oppose to basic black with bold white logo that the prior stick holders/bags have. The purpose is to have their school/club/organization/groups name label or title monogrammed, on the invented stick bags (this is optional), but the size of the letters can or will vary.

According from past creation of the percussion stick bags they have been made on an impersonal level. Back years ago in the late 1970's to the early 80's, most manufactured drums were somewhat large and bulky. Now here in the new Millennium; they make the new and improved snare drums along with the attached hardware a more streamline/sleek look. The companies for Yamaha/Pearl/Ludwig/Premier etc., has stepped their game up and by doing this, my stick bags will compliment their new and improved retro style marching instruments.

The Stick Bag will match the company's different contrasting shells. The other companies that currently manufacture these bags are large and bulky.

All the corresponding manufactures produce the same style—basic black nylon stick bags. Being that they are in basic black other clubs/schools with odd colors or mascots would not compliment the whole color scheme.

Ramifications:

other ideas and ways that the stick bags can be used and altered is that you can interchange the snare stick bags the same way to the Bass Drum/Tenor/Quads or Quints.
it not only applies to the marching aspect of drums and percussion. You can apply these bags to the Drum Set.
also these stick bags to be use in the percussion pit on the field or Concert or a Symphonic Band setting.

Many of the devises/drum/instruments require special sticks or beaters. Prior art devices for marching percussionist are usually uncomfortable, cumbersome not functional and ineffective during the time performance.

The inventor Clouse, U.S. Pat. No. D319,836, describes a stick holder with two narrow holders, which was not made for marching. The inventor Pults, U.S. Pat. No. 5,435,220, describes a complex stick holster storing, it is too cumbersome to retrieve drumstick out of the leather casing with all these different mechanisms. In addition, the Holster was to be strapped to the drummer; my design is to be strapped/secured to the Marching Drum/Instrument itself.

McLennan, U.S. Pat. No. 5,199,621 is another leather holster, and it was not made in a variety of colors. Neither of them has an assortment of textured fabric. Most of them were made of PVC type plastic tubing or some form of leather. All these prior designs are so call original in their own way, but they are not as unique as to my design.

[image]

I claim:

1) An apparatus/device for holding/storing and the retrieval of one or more pair of marching percussion drumsticks/mallets/beaters. Comprising in a combination of: a casing open at its top and defining a cavity 12 with a pocket lining. The other end of the casing is closed for stopping the drumsticks from falling/coming out which consist as a base 16. The two (2) stitched Velcro straps 14 to be secured or strap to the marching percussion instrument. The two straps at each end of the Main Body 10, are equally stitched or parallel to one other.

2) That this stick bag/holder has a custom hand made casing/opening 12 constructed of a cloth/fabric material. Witch is also stitched together in a separate variety of solid colors: PLEASE SEE LEGEND.
